(19) United States
(12) Patent Application Publication
(10) Pub. No.: US 2024/0118911 A1
(43) Pub. Date: Apr. 11, 2024

(54) METRIC-AWARE MULTI-CLOUD MIDDLEBOX SERVICE

(71) Applicant: VMware, Inc., Palo Alto, CA (US)

(72) Inventors: Manu Dilip Shah, Barabanki (IN); Nikhil Kumar Yadav, New Delhi (IN); Tilak Bisht, Bangalore (IN); Sooraj Tom, Kootayam (IN); Satyajit Panda, Bangalore (IN)

(21) Appl. No.: 17/960,802

(22) Filed: Oct. 5, 2022

(51) Int. Cl. G06F 9/455; G06F 9/50

(52) U.S. Cl. CPC G06F 9/45558; G06F 9/50

(57) ABSTRACT

Some embodiments provide a novel method of deploying a secondary cluster of one or more service machines to a public secondary cloud to provide a service to supplement a primary cluster of service machines that provide the service in a primary cloud. The method receives a set of one or more user-defined criteria to use to deploy the secondary cluster in the public secondary cloud. After receiving the set of user-defined criteria, the method detects that the secondary cluster is needed to supplement the primary cluster. The method retrieves previously collected data about different public clouds that are candidates for the deployment of the secondary cluster. Based on the set of user-defined criteria, the method analyzes the previously collected data to select for the deployment a particular candidate public cloud as the public secondary cloud. Then, the method deploys the secondary cluster in the selected particular public cloud.

### BACKGROUND

Middlebox services deploy service clusters when the request load increases. These deployments can be either in private datacenters (private cloud) or completely in a public cloud. When the capacity reaches a point where there are inadequate resources in the configured cloud, the middlebox services need to be scaled to a different cloud. The current deployments for middlebox services do not consider performance metrics and non-performance metrics of the resource and location of the datacenters provided by different cloud providers, such as the datacenters' cost and latency. There is differential pricing based on different instance sizes, different regions, reserved and spot virtual machines (VMs) or on demand VMs, which results in the end user paying more to these cloud providers, the application suffering latency issues, or both. The goal is to provide a multi-cloud scalable middlebox service solution which is cost- and latency-aware, and minimizes either or both.

### BRIEF SUMMARY

Some embodiments provide a novel method of deploying a secondary cluster of one or more service machines to a public secondary cloud to provide a service to supplement a primary cluster of service machines that provide the service in a primary cloud. The method receives a set of one or more user-defined criteria to use to deploy the secondary cluster of service machines in the public secondary cloud. After receiving the set of user-defined criteria, the method detects that the secondary cluster is needed to supplement the primary cluster of service machines. The method retrieves previously collected data about several different public clouds that are candidates for the deployment of the secondary cluster of service machines. Based on the set of user-defined criteria, the method analyzes the previously collected data to select for the deployment a particular candidate public cloud as the public secondary cloud. Then, the method deploys the secondary cluster of service machines in the selected particular public cloud.

In some embodiments, the primary cloud is a private cloud. For a private cloud, the request load for a particular service (e.g., a middlebox service) increases to a point where the private cloud must deploy a cluster of service machines in one or more public clouds in order to meet the demand. This process is called bursting. In some embodiments, selecting a public secondary cloud for deploying such service machines is dependent on several parameters, such as cost of the public cloud, latency of the public cloud, etc. In order to select the public cloud that meets the expectations of the user, user-defined criteria and metrics associated with candidate public clouds are analyzed to select the best possible choice.

The set of user-defined criteria in some embodiments includes a cost parameter and at least one performance parameter. The cost parameter is a financial cost charged by the public secondary cloud. For example, different cloud providers charge different amounts for the same size machine (e.g., virtual machine (VM), container, etc.), and a cost parameter specifies the cost the user desires to pay to use the public secondary cloud for deploying the secondary cluster. The at least one performance parameter is at least one of (1) a latency metric, (2) a capacity metric, (3) a central processing unit (CPU) utilization metric, (4) a memory utilization metric, (5) an error rate metric, and (6) a mean time to repair metric of the public secondary cloud. Any suitable performance metrics for a public cloud may be defined as criteria for selecting the public secondary public cloud. In some embodiments, the cost and performance parameters are expressed as relative weight values to express relative importance for each parameter. A user defines the relative weight values for the parameters such that the public secondary cloud is selected based on the candidate public clouds' abilities to optimize the relative weight values of the parameters. In some embodiments, the previously collected data about the candidate public clouds includes cost data and performance metric data retrieved from each candidate public cloud. This data may be collected and maintained by each public cloud. The method of some embodiments periodically retrieves the cost and performance metric data from each candidate public cloud in order to maintain up-to-date data for the candidate public clouds. In such embodiments, the most recently retrieved cost and performance metric data is used to select the public secondary cloud.

The method compares the user-defined cost and performance parameters and relative weight values with the retrieved cost and performance metric data of the candidate public clouds to select the public secondary cloud. In some embodiments, the public secondary cloud is selected by matching the candidate public clouds' previously collected data with the user-defined criteria such that the public secondary cloud's data best satisfy the user-defined criteria out of all the candidates. For example, if the user defines a cost parameter, collected cost metrics for each candidate public cloud are compared to the cost parameter and the public secondary cloud is selected because its cost metric best matches the cost parameter. In some embodiments, the user specifies two or more parameters (e.g., two or more performance parameters, a cost parameter and one or more performance parameters, etc.), and specifies relative weight values for each parameter. For example, a user may specify that a latency metric is more important than the cost parameter, by assigning a weight of 0.7 to the latency metric and a weight of 0.3 to the cost parameter. By receiving these weights of the parameters, a public cloud can be selected based on the parameters, the candidate public clouds' metrics, and the weight values.

The different candidate public clouds in some embodiments include different public clouds of different public cloud providers. Examples of public cloud providers include Amazon Web Services® (AWS), Google Cloud Platform™ (GCP), Microsoft Azure®, etc. In other embodiments, the different candidate public clouds include different public clouds of a first public cloud provider. In these embodiments, the different public clouds of the first public cloud provider are different availability zones of the first public cloud provider. An availability zone is an isolated location of one or more datacenters within one geographic region (e.g., a city, state, country, etc.) from which public cloud originates and operates. In some embodiments, the method further selects a particular datacenter of the selected particular public cloud and deploys the secondary cluster of service machines in the selected particular datacenter.

In some embodiments, the deployed service is a middlebox service. The middlebox service may be one of (1) a load balancing service, (2) a firewall service, (3) a deep packet inspection (DPI) service, (4) an intrusion detection system (IDS) service, (5) an intrusion prevention (IPS) service, (6) a wide-area network (WAN) link optimization service, or (7) a network address translation (NAT) service. Any middlebox service is suitable for the primary and secondary clusters of service machines to perform.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a virtual network that is defined for a corporation over several public cloud datacenters of two public cloud providers.

FIG. 2 an example system for deploying service machines in public clouds.

FIG. 3 conceptually illustrates a process of some embodiments for deploying a cluster of one or more service machines to a public cloud to perform a service.

FIG. 4 illustrates tables for storing metrics related to public clouds.

FIG. 5 illustrates an example process for deploying middlebox services in a private primary cloud and a public secondary cloud based on a public cloud selection process.

FIG. 6 conceptually illustrates a process of some embodiments for selecting a public cloud to deploy a service machine cluster based on public clouds and spot instance clouds.

FIG. 7 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method of deploying a secondary cluster of one or more service machines to a public secondary cloud to provide a service to supplement a primary cluster of service machines that provide the service in a primary cloud. The method receives a set of one or more user-defined criteria to use to deploy the secondary cluster of service machines in the public secondary cloud. After receiving the set of user-defined criteria, the method detects that the secondary cluster is needed to supplement the primary cluster of service machines. The method retrieves previously collected data about several different public clouds that are candidates for the deployment of the secondary cluster of service machines. Based on the set of user-defined criteria, the method analyzes the previously collected data to select for the deployment a particular candidate public cloud as the public secondary cloud. Then, the method deploys the secondary cluster of service machines in the selected particular public cloud.

In some embodiments, the service is a middlebox service. This middlebox service may be one of (1) a load balancing service, (2) a firewall service, (3) a deep packet inspection (DPI) service, (4) an intrusion detection system (IDS) service, (5) an intrusion prevention (IPS) service, (6) a wide-area network (WAN) link optimization service, or (7) a network address translation (NAT) service. Any middlebox service is suitable for the primary and secondary clusters of service machines to perform

In some embodiments, a virtual network is established over several public cloud datacenters of one or more public cloud providers. Examples of public cloud providers include Amazon Web Services (AWS)®, Google Cloud Platform™ (GCP), Microsoft Azure®, etc. Some embodiments define the virtual network as an overlay network that spans across several public cloud datacenters (public clouds) to interconnect one or more private networks (e.g., networks within branches, divisions, and/or departments of the entity or their associated datacenters), mobile users, SaaS (Software-as-a-Service) provider machines, machines and/or services in the public cloud(s), and other web applications. In some embodiments, high-speed, reliable private networks interconnect two or more of the public cloud datacenters.

Some embodiments establish the virtual network by configuring several components that are deployed in several public clouds. These components include in some embodiments software-based measurement agents, software forwarding elements (e.g., software routers, switches, gateways, etc.), layer-4 connection proxies, and middlebox service machines (e.g., appliances, VMs, containers, etc.). In other embodiments, an overlay network does not need to be established for components in different public clouds to communicate.

Some embodiments utilize a logically centralized controller cluster (e.g., a set of one or more controller servers) that configures the public-cloud components to implement the virtual network over several public clouds. In some embodiments, the controllers in this cluster are at various different locations (e.g., are in different public cloud datacenters) in order to improve redundancy and high availability. When different controllers in the controller cluster are located in different public cloud datacenters, the controllers in some embodiments share their state (e.g., the configuration data that they generate to identify tenants, routes through the virtual networks, etc.). The controller cluster in some embodiments scales up or down the number of public cloud components that are used to establish the virtual network, or the compute or network resources allocated to these components.

As used in this document, data messages refer to a collection of bits in a particular format sent across a network. One of ordinary skill in the art will recognize that the term data message is used in this document to refer to various formatted collections of bits that are sent across a network. The formatting of these bits can be specified by standardized protocols or non-standardized protocols. Examples of data messages following standardized protocols include Ethernet frames, IP packets, TCP segments, UDP datagrams, etc.

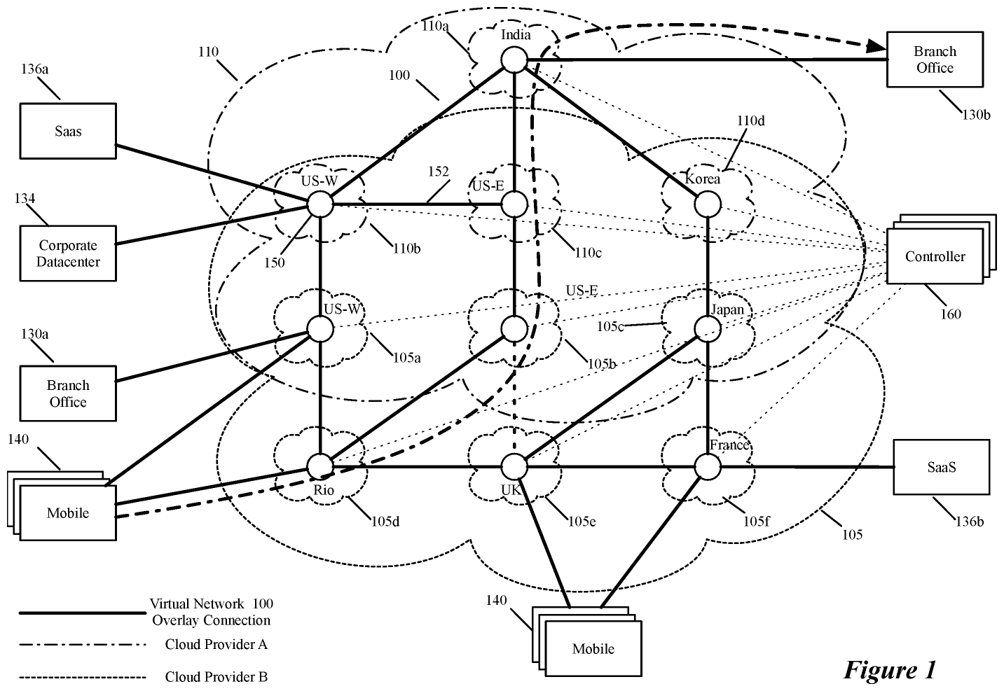

FIG. 1 presents a virtual network 100 that is defined for a corporation over several public cloud datacenters 105 and 110 of two public cloud providers A and B. As shown, the virtual network 100 is a secure overlay network that is established by deploying different managed forwarding nodes 150 in different public clouds and connecting the managed forwarding nodes (MFNs) to each other through overlay tunnels 152. In some embodiments, an MFN is a conceptual grouping of several different components in a public cloud datacenter that with other MFNs (with other groups of components) in other public cloud datacenters establish one or more overlay virtual networks for one or more entities.

As further described below, the group of components that form an MFN include in some embodiments (1) one or more virtual private network (VPN) gateways for establishing VPN connections with an entity's compute nodes (e.g., offices, private datacenters, remote users, etc.) that are external machine locations outside of the public cloud datacenters, (2) one or more forwarding elements for forwarding encapsulated data messages between each other in order to define an overlay virtual network over the shared public cloud network fabric, (3) one or more service machines for performing middlebox service operations as well as L4-L7 optimizations, and (4) one or more measurement agents for obtaining measurements regarding the network connection quality between the public cloud datacenters in order to identify desired paths through the public cloud datacenters. In some embodiments, different MFNs can have different arrangements and different numbers of such components, and one MFN can have different numbers of such components for redundancy and scalability reasons.

Also, in some embodiments, each MFN's group of components execute on different computers in the MFN's public cloud datacenter. In some embodiments, several or all of an MFN's components can execute on one computer of a public cloud datacenter. The components of an MFN in some embodiments execute on host computers that also execute other machines of other tenants. These other machines can be other machines of other MFNs of other tenants, or they can be unrelated machines of other tenants (e.g., compute VMs or containers).

The virtual network 100 in some embodiments is deployed by a virtual network provider (VNP) that deploys different virtual networks over the same or different public cloud datacenters for different entities (e.g., different corporate customers/tenants of the VNP). The VNP in some embodiments is the entity that deploys the MFNs and provides the controller cluster for configuring and managing these MFNs.

The virtual network 100 connects the corporate compute endpoints (such as datacenters, branch offices, and mobile users) to each other and to external services (e.g., public web services, or SaaS services such as Office 365® or Salesforce®) that reside in the public cloud or reside in private datacenter accessible through the Internet. This virtual network leverages the different locations of the different public clouds to connect different corporate compute endpoints (e.g., different private networks and/or different mobile users of the corporation) to the public clouds in their vicinity. Corporate compute endpoints are also referred to as corporate compute nodes in the discussion below.

In some embodiments, the virtual network 100 also leverages the high-speed networks that interconnect these public clouds to forward data messages through the public clouds to their destinations or to get as close to their destinations while reducing their traversal through the Internet. When the corporate compute endpoints are outside of public cloud datacenters over which the virtual network spans, these endpoints are referred to as external machine locations. This is the case for corporate branch offices, private datacenters, and devices of remote users.

In the example illustrated in FIG. 1, the virtual network 100 spans six datacenters 105a-105f of the public cloud provider A and four datacenters 110a-110d of the public cloud provider B. In spanning these public clouds, this virtual network connects several branch offices, corporate datacenters, SaaS providers, and mobile users of the corporate tenant that are located in different geographic regions. Specifically, the virtual network 100 connects two branch offices 130a and 130b in two different cities (e.g., San Francisco, California, and Pune, India), a corporate datacenter 134 in another city (e.g., Seattle, Washington), two SaaS provider datacenters 136a and 136b in another two cities (Redmond, Washington, and Paris, France), and mobile users 140 at various locations in the world. As such, this virtual network 100 can be viewed as a virtual corporate WAN.

In some embodiments, the branch offices 130a and 130b have their own private networks (e.g., local area networks) that connect computers at the branch locations and branch private datacenters that are outside of public clouds. Similarly, the corporate datacenter 134 in some embodiments has its own private network and resides outside of any public cloud datacenter. In other embodiments, however, the corporate datacenter 134 or the datacenter of the branch 130a and 130b can be within a public cloud, but the virtual network 100 does not span this public cloud, as the corporate or branch datacenter connects to the edge of the virtual network 100.

As mentioned above, the virtual network 100 is established by connecting different deployed MFNs 150 in different public clouds through overlay tunnels 152. Each MFN 150 includes several configurable components. The MFN components include in some embodiments software-based measurement agents, software forwarding elements (e.g., software routers, switches, gateways, etc.), layer-4 proxies (e.g., TCP proxies), and middlebox service machines (e.g., VMs, containers, etc.). One or more of these components in some embodiments use standardized or commonly available solutions, such as Open vSwitch, OpenVPN, strongSwan, etc.

In some embodiments, each MFN (i.e., the group of components the conceptually forms an MFN) can be shared by different tenants of the VNP that deploys and configures the MFNs in the public cloud datacenters. Conjunctively, or alternatively, the VNP in some embodiments can deploy a unique set of MFNs in one or more public cloud datacenters for a particular tenant. For instance, a particular tenant might not wish to share MFN resources with another tenant for security reasons or quality of service reasons. For such a tenant, the VNP can deploy its own set of MFNs across several public cloud datacenters.

In some embodiments, a logically centralized controller cluster 160 (e.g., a set of one or more controller servers) operate inside or outside of one or more of the public clouds 105 and 110, and configure the public-cloud components of the managed forwarding nodes 150 to implement the virtual network 100 over the public clouds 105 and 110. In some embodiments, the controllers in this cluster 160 are at various different locations (e.g., are in different public cloud datacenters) in order to improve redundancy and high availability. The controller cluster 160 in some embodiments scales up or down the number of public cloud components that are used to establish the virtual network 100, or the compute or network resources allocated to these components.

For a private cloud (or a private datacenter), the request load for a particular service (e.g., a middlebox service) increases to a point where the private cloud must deploy a cluster of service machines in one or more public clouds in order to meet the demand. This process is called bursting. In some embodiments, selecting a public secondary cloud for deploying such service machines is dependent on several parameters, such as cost of the public cloud, latency of the public cloud, etc. In order to select the public cloud that meets the expectations of the user, user-defined criteria and metrics associated with candidate public clouds are analyzed to select the best possible choice. Selecting the optimal public cloud for deploying a middlebox service helps users optimize metrics (e.g., reducing cost, improving response time, etc.) while using public cloud machines.

The different candidate public clouds in some embodiments include different public clouds of different public cloud providers. In other embodiments, the different candidate public clouds include different public clouds of a first public cloud provider. In these embodiments, the different public clouds of the first public cloud provider are in different availability zones of the first public cloud provider. An availability zone is an isolated location of one or more datacenters within one geographic region (e.g., a city, state, country, etc.) from which the public cloud originates and operates. In some embodiments, the method further selects a particular datacenter of the selected particular public cloud and deploys the secondary cluster of service machines in the selected particular datacenter.

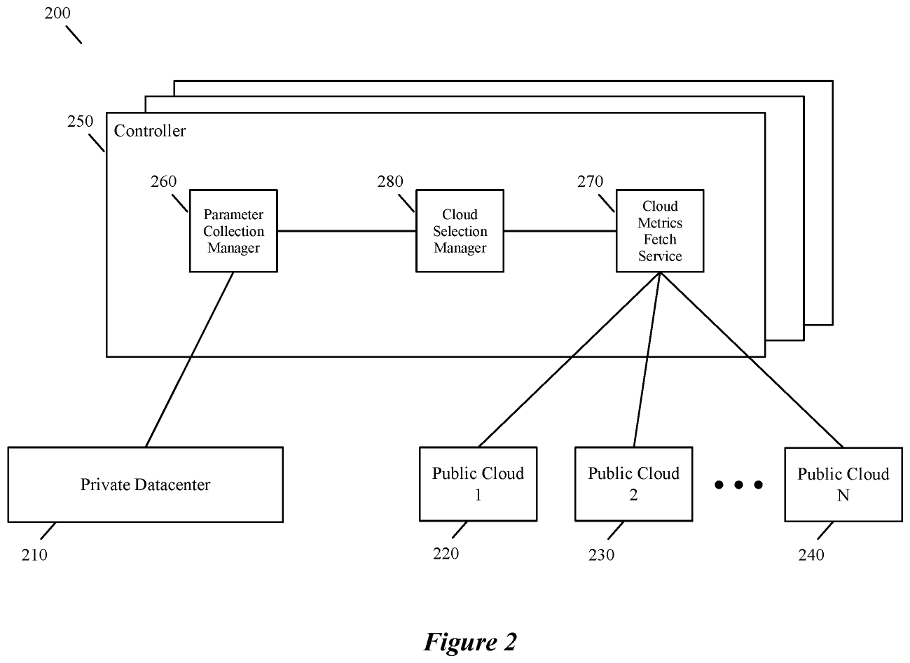

FIG. 2 illustrates an example system 200 for deploying service machines. The system 200 includes a private datacenter 210 and several public clouds 220-240. The system 200 may include any number of public clouds that are candidates for deploying service machines. In some embodiments, two or more public clouds operate in different physical locations or geographic regions (e.g., cities, states, countries, etc.). Public clouds can also each operate in one or more regions. For example, public cloud 1 220 may include one datacenter operating in a first region, while public cloud 2 230 may include two datacenters operating respectively in second and third regions. As another example, public cloud 1 220 may include two datacenters operating in first and second regions, and public cloud 2 230 may include two datacenters operating in the first and a third region. While both public clouds 220 and 230 include a datacenter in the same region, they also include other datacenters in other regions.

A user or administrator of the private datacenter 210 may deploy clusters of one or more service machines in any of the public clouds 220-240. In order to select a public cloud to deploy a service machine cluster, the user communicates with a set of one or more controllers 250. The controller set 250 includes a parameter collection manager 260 that receives a set of parameters from the user for selecting a public cloud. In some embodiments, a user of some embodiments provides these parameters as a set of user-defined criteria to the parameter collection manager 260 such that a public cloud that best meets the parameters is selected for deploying a service machine cluster. In some embodiments, the parameters include performance parameters and non-performance parameters. For instance, the set of user-defined criteria can include a cost parameter and one or more performance parameters. The cost parameter is a financial cost charged by the public secondary cloud. For example, different cloud providers charge different amounts for the same size machine (e.g., VM, container, etc.), and a cost parameter specifies the cost the user desires to pay to use the selected public cloud.

The one or more performance parameters can be at least one of (1) a latency metric measuring the latency of the public cloud, (2) a capacity metric measuring the size of the workload compared to the public cloud's available infrastructure, (3) a CPU-utilization metric measuring the percentage of compute units used for the public cloud, (4) a memory utilization metric measuring the memory usage of the public cloud, (5) an error rate metric measuring how often a request to the public cloud results in an error, and (6) a mean-time-to-repair metric measuring the average time it takes to repair a failed cloud component of the public cloud and get it back in service. Any suitable performance and non-performance metrics for a public cloud may be defined as criteria for selecting a public cloud to deploy a service machine cluster.

The controller set 250 in some embodiments also includes a cloud metrics fetch service 270 for retrieving data for each of the candidate public clouds 220-240. For instance, the cloud metrics fetch service 270 may retrieve performance metrics and non-performance metrics for each public cloud that are used in selecting a public cloud for service machine deployment. In some embodiments, these metrics have been previously collected for each public cloud 220-240 and are available for retrieval by the cloud metrics fetch service 270. For instance, cloud providers can provide metrics regarding their public cloud and their machines on their website for the cloud metrics fetch service 270 to retrieve. In some embodiments, the cloud metrics fetch service 270 periodically retrieves metric data from each candidate public cloud 220-240 in order to maintain up-to-date data for the candidate public clouds, and the controller set 250 uses the most recently retrieved metric data to select a public cloud.

Using the user-defined criteria (i.e., the parameters) and the collected data (i.e., the public clouds' metrics) from the public clouds 220-240, a cloud selection manager 280 of the controller 250 selects the best public cloud of all candidates for deploying the service machine cluster. In some embodiments, deploying a service machine cluster in one public cloud results in different outcomes than if the cluster were deployed in another public cloud. For instance, different public clouds require different costs for using similar machines, and the user may specify a desired cost (e.g., a maximum cost or a cost range the user wishes to spend for deploying the cluster) in the user-specified criteria. Using the metrics retrieved for the candidate public clouds, the cloud selection manager 180 can select the public cloud that best fits the user's desired cost. If the user were to deploy the cluster in a public cloud that does not meet their desired cost, the user will pay more for the same service because the non-optimal public cloud was used.

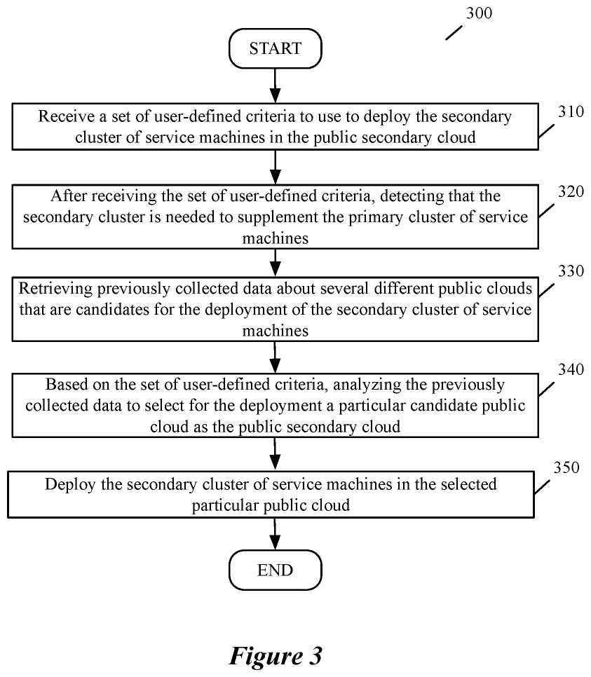

FIG. 3 conceptually illustrates a process 300 of some embodiments for deploying a secondary cluster of one or more service machines to a public secondary cloud to provide a service to supplement a primary cluster of service machines that provide the service in a primary cloud. In some embodiments, this process 300 is performed by a controller or a controller set similar to the controller set 250 of FIG. 2. The primary cloud of some embodiments is a private cloud, and the controller selects a public secondary cloud to supplement a primary service machine cluster providing the service in the private primary cloud.

The process 300 begins by receiving (at 310) a set of one or more user-defined criteria to use to deploy the secondary cluster of service machines in the public secondary cloud. The controller receives this criteria set from the user in order to consider the user's preferences in selecting a public cloud. In some embodiments, the set of user-defined criteria includes parameters to use in selecting a public cloud. The set of user-defined criteria may also include relative weight values to express the relative importance for each parameter. A user defines the relative weight values for the parameters such that the public secondary cloud is selected based on the candidate public clouds' abilities to optimize the relative weight values of the parameters. For example, for deploying a load balancing service cluster, a user may specify desired cost and latency parameters the user wishes the selected public cloud meets. The user may also specify that the desired latency parameter is more important than the desired cost parameter, by assigning a weight of 0.7 to the desired latency metric and a weight of 0.3 to the desired cost metric. Weight values are normalized values on a scale of 0 to 1, or 0% to 100%. By receiving these weights of the desired parameters, a public cloud can be selected based on both the desired parameters and their assigned weight values.

After receiving the set of user-defined criteria, the process 300 detects (at 320) that the secondary cluster is needed to supplement the primary cluster of service machines. In some embodiments, the controller detects that the secondary cluster is needed by receiving a data message from the user. In other embodiments, the controller detects that the secondary cluster is needed by monitoring the primary service machine cluster in the primary cloud and the load on the primary cluster. When the load reaches a specified threshold (e.g., a threshold specified by the user), the controller detects that the secondary cluster is needed in order to alleviate the load on the primary cluster. Next, the process 300 retrieves (at 330) previously collected data about several different public clouds that are candidates for the deployment of the secondary cluster of service machines. The controller may retrieve this previously collected data directly from the public clouds. For example, cloud providers provide performance and non-performance metrics, such as latency and cost, and the controller retrieves these metrics from the cloud providers.

Based on the ser of user-defined criteria, the process 300 analyzes (at 340) the previously collected data to select for the deployment a particular candidate public cloud as the public secondary cloud. Analyzing the previously collected data using the user-defined criteria in some embodiments includes comparing the previously collected data with the user-defined criteria to select a public cloud from the candidate public clouds. In some embodiments, the previously collected data includes metrics associated with each candidate public cloud, and the user-defined criteria includes parameters specifying desired metrics from the user. The particular public cloud is then selected by matching the candidate public clouds' metrics with the user's desired metrics such that the particular public cloud's metrics best satisfy the desired metrics out of all the candidates. For example, if the user specifies a desired cost metric, collected cost metrics for each candidate public cloud are compared to the user's desired cost and the particular public cloud is selected because its cost metric best matches the desired cost metric.

In some embodiments, the user specifies two or more parameters (e.g., two or more performance parameters, a cost parameter and one or more performance parameters, etc.), and specifies relative weight values for each parameter. For example, a user may specify that latency of the public cloud is more important than the cost of the public cloud by assigning a weight of 0.7 to the latency parameter and a weight of 0.3 to the cost parameter. Using the parameters and weights received from the user and the metrics collected for each public cloud, the controller selects the public cloud that best meets the preferences of the user based on its metrics. For example, for deploying a load balancing service cluster using latency and cost metrics, the controller of some embodiments uses the following equation for each public cloud to calculate a value for the public cloud.

$${min}_{𝒾 ∈ I} ( CostFactor * {InstanceCost}_{𝒾} + LatencyFactor * {InstanceLatency}_{𝒾} ) \qquad ( 1 )$$

Where “I” is set of all machines across different public clouds, “CostFactor” is the assigned weight for cost metrics, “Instance Cost” is the collected cost metric for the public cloud, “Latency Factor” is the assigned weight for cost metrics, and “Instance Latency” is the collected latency metric for machines across public clouds. In this example, the user has specified, in the parameter set, that the desired public cloud is the least expensive (i.e., has the lowest cost metric) and the fastest (i.e., has the lowest latency metric), and has assigned weights to the latency and cost metrics to understand which of the two metrics matters more to the user. These weights, in some embodiments, sum to 1, as shown in the following equation.

CostFactor+LatencyFactor=1 (2)

Different embodiments can use any suitable values for these weights, such as a percentage scale such that the weights equal 100%. By using weights assigned to metrics, the controller is able to generate normalized metric values for the cost and latency metrics such that they can be combined (e.g., summed) into a single value for each public cloud representing its ability to meet the expectations specified by the user. Using equation 1, the controller determines a value for each public cloud, and then compares each of those values to determine the best public cloud for deploying the load balancing service cluster. In some embodiments, metrics collected for public clouds and the parameters specified by the user are non-numerical values, such as metrics specifying the region or regions spanned by a public cloud. For such metrics, the controller may assign numerical values to different non-numerical metrics, such as assigning a first region a value of 1 and a second region a value of 2. In doing so, the controller can generate normalized metric values using the assigned numerical values for the metrics, and generate the single numerical value for the public cloud. The received parameters for these non-numerical metrics can also be assigned numerical values, and the controller can then compare these numerical values of the collected metrics and the parameters from the user to select the public cloud to deploy the service machines.

In some embodiments, the same type of machine for one public cloud is associated with different metrics. For example, one type of machine can cost differently in different regions of the same public cloud. A public cloud can have three datacenters in three different geographic regions, and the price to deploy service machines in the different datacenters can cost a different amount in each of those datacenters of the same public cloud. Some embodiments also provide different pricing based on reserved machines, i.e., based on the duration for which the machine is reserved. For reserved machines, prices can go as low as 30% to as high as 60%, depending on the duration of the reservation and the type of machine. Because of these issues, the controller of some embodiments selects the public cloud best matching the parameters specified by the user out of all candidate public clouds, and further selects the datacenter, and sometimes selects the particular machine, best matching those parameters out of all datacenters of the selected public cloud. The datacenter and the machine can be selected using the same process or calculation as selecting the public cloud (e.g., comparing collected metrics with desired metrics from the user), or can be selected using a different process or calculation.

Lastly, the process 300 deploys (at 350) the secondary cluster of service machines in the selected particular public cloud. Once the controller selects the particular cloud, the service machine cluster can be deployed in the selected public cloud. In some embodiments, the controller deploys the cluster itself in the selected public cloud. In other embodiments, the controller sends a data message to the user notifying of the selected public cloud for the user to deploy the cluster (e.g., via another controller). In embodiments where a particular datacenter of the selected public cloud is selected, the cluster is deployed in the particular datacenter. Then, the process 300 ends.

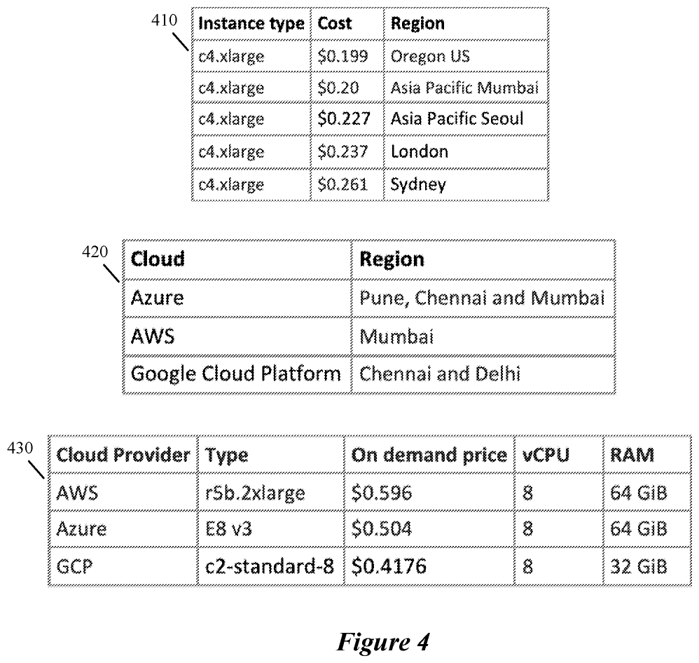

As discussed previously, a controller (e.g., a cloud metrics fetch service of a controller) may retrieve previously collected data for public clouds for use in selecting a public cloud for deploying a cluster of service machines. FIG. 4 illustrates example tables organizing this data collected by the controller. In some embodiments, metrics collected by the controller are organized and stored in tables, as shown in this figure. However, other embodiments may store metrics in any other suitable format.

Table 410 lists, for one public cloud provider, the different prices and regions for the same type of machine (also referred to as an instance) offered by this cloud provider. Table 410 lists, for a c4.xlarge instance, (1) it costs $0.199 for this instance in Oregon, USA, (2) it costs $0.20 for this instance in Mumbai, India, (3) it costs $0.227 for this instance in Seoul, South Korea, (4) it costs $0.237 for this instance in London, United Kingdom, and (5) it costs $0.261 for this instance in Sydney, Australia. These metrics in some embodiments are recorded by the public cloud provider, and are stored by the cloud provider for the controller to collect and use to select a public cloud or a datacenter of a public cloud.

Table 420 lists the different region or regions in India spanned by different public cloud providers. For example, Azure spans the cities of Pune, Chennai, and Mumbai. AWS only spans Mumbai. GCP spans Chennai and Delhi. In this example, two public clouds span more than one region, while one public cloud spans only one region. These cloud providers also show that different cloud providers can be present in the same regions, such as Azure and AWS in Mumbai. Using this information regarding which regions public cloud providers are present, the controller can generate numerical normalized metric values to use to compare with regions the user desires to deploy the service machine cluster and select one of these public cloud providers (and in some embodiments select one region of the selected cloud provider).

Table 430 lists different cloud providers, the type of machine they offer, the price for that machine, the virtual central processing unit (vCPU), and the random-access memory (RAM). This table shows that, while different public cloud providers offer different prices, they offer similar machines. All cloud providers offer a vCPU of 8. AWS and Azure offer a RAM of 64 gibibytes (GiB), while GCP offers 32 GiB. While these cloud providers offer similar instances, they offer different prices with AWS offering $0.596, Azure offering $0.504, and GCP offering $0.4176. In this example, the prices are without using persistent disks. By collecting and storing these metrics, the controller can compare the different costs of each public cloud to select the public cloud most similar to the user's desired cost.

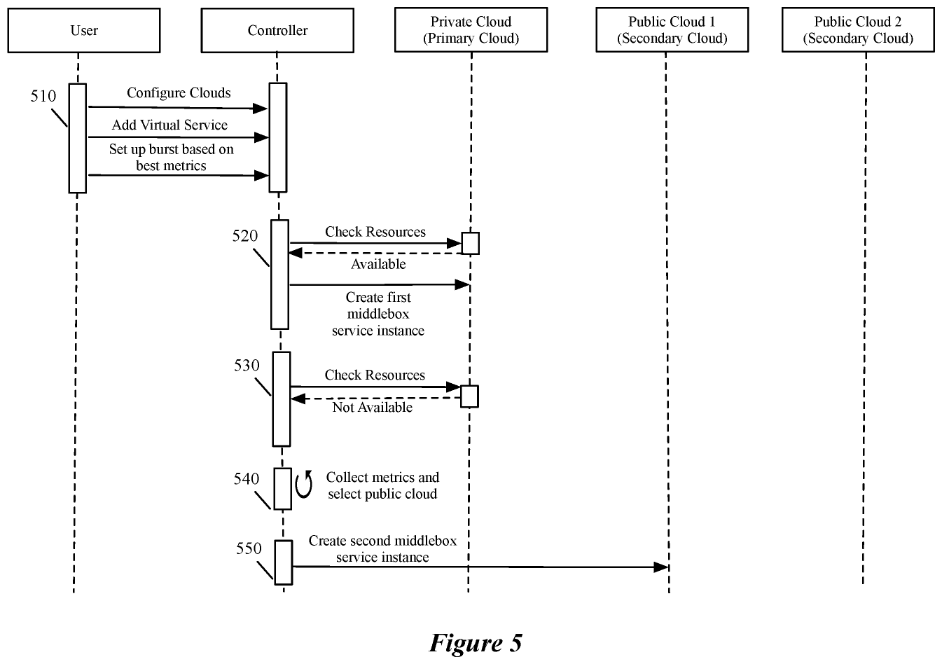

FIG. 5 illustrates an example process for deploying middlebox services first in a private primary cloud and second in a public secondary cloud based on a public cloud selection process. In this example, there are two candidate public clouds for deploying middlebox service instances. However, any number of candidate public clouds may be considered for deploying middlebox service instances for the user. At 510, the user requests the controller to configure clouds, add virtual services, and set up a burst based on best metrics, i.e., request the controller to select a public cloud and deploy middlebox service instances based on metrics when resources in the private primary cloud are unavailable. For example, for deploying a load balancing service instance, the user can request the controller instantiate load balancing service instances in the private cloud and also in a public cloud, which is selected by the controller based on the lowest cost and best latency of the candidate public clouds.

At 520, the controller checks the resources of the private cloud. Once the controller determines that the resources of the private cloud are available, the controller creates a first middlebox service instance in this cloud. This private cloud is designated as the primary cloud, meaning that the controller does not perform a public cloud selection process and only uses this private cloud, as long as the private cloud's resources are available. At 530, after the first middlebox service instance is deployed, the controller checks the resources of the private primary cloud again for deploying a second middlebox service instance. In some embodiments, the controller monitors the resources of the private primary cloud and the load on the private primary cloud in order to determine whether the resources are available. When the controller determines that the private primary cloud's resources are unavailable, the controller can select a public secondary cloud for deploying the second middlebox service instance.

At 540, the controller collects metrics for all candidate public secondary clouds (in this example, public clouds 1 and 2). The controller, having already received parameters from the user at 510 for setting up the burst, compares the collected metrics with the parameters from the user to select the first public cloud as the best choice for deploying the second middlebox service instance. After the selection is complete, the controller creates the second middlebox service instance at 550 in the selected secondary public cloud.

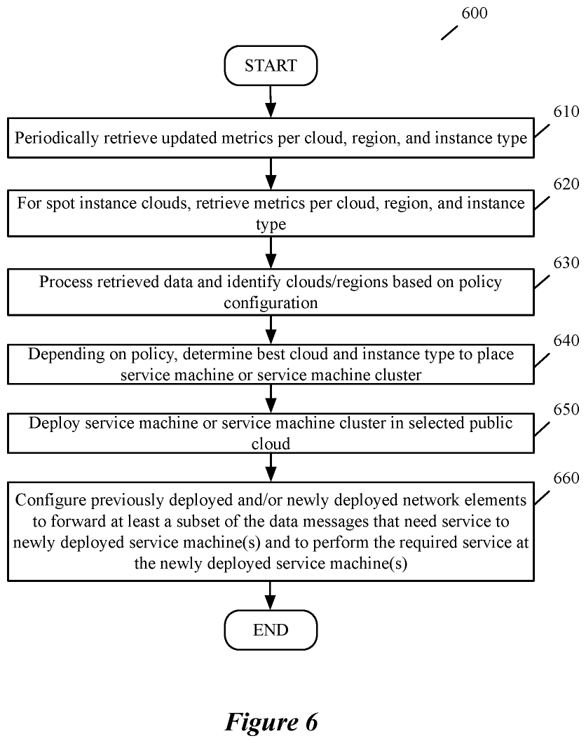

In some embodiments, controllers consider metrics associated with spot instances in selecting a public cloud. Spot instances are machines not covered by service level agreements (SLAs), and are less expensive compared to other instances. FIG. 6 conceptually illustrates a process 600 for selecting a public cloud to deploy a cluster of one or more service machines based on public clouds and spot instance clouds. This process 600 can be performed by a controller or a controller set, such as the controller set 250 of FIG. 2. The process 600 begins by periodically retrieving (at 610) updated metrics per public cloud, region, and instance type. For each candidate public cloud, the controller periodically retrieves metrics related to the public cloud, the regions in which it operates, and the machine types it provides. These metrics can be retrieved periodically, or iteratively, such that the controller keeps an up-to-date list of these metrics in order to select the optimal public cloud based on their most recently collected metrics.

Next, for spot instance public clouds, the process 600 retrieves (at 620) metrics per public cloud, region, and instance type. The controller retrieves all metrics associated with spot instance clouds (i.e., public clouds that provide spot instances) in order to consider these public clouds as candidates for deploying service machines. In some embodiments, these metrics are also retrieved periodically by the controller. In other embodiments, these metrics are retrieved only when performing the process 600 to select a public cloud for deployment of a service machine cluster.

Then, the process 600 processes (at 630) the retrieved data and identifies clouds and/or regions based on a policy configuration. The policy configuration is in some embodiments the user-defined criteria and parameters for selecting a public cloud, such as desired metric values and weights. Based on these parameters, the controller processes the metrics for the public clouds and the spot instance public clouds.

Next, depending on the policy, the process 600 determines (at 640) the best public cloud and instance type to place a service machine or a service machine cluster. Based on the parameters provided by the user, the controller compares all candidate public clouds (including spot instance public clouds) to determine the best match for the policy configuration (i.e., the users parameters and desired metrics). In some embodiments, the controller determines the best match public cloud for deploying one service machine. In other embodiments, the controller determines the best match public cloud for deploying a cluster of several service machines. At 650, the process 600 deploys the service machine or the service machine cluster in the selected public cloud. The selected public cloud best satisfies the policy configuration out of all the candidate public clouds, and, hence, the deployed service machine (or service machines) is provided the criteria specified by the user.

After deploying the service machine cluster, the process 600 configures (at 660) previously deployed and/or newly deployed network elements to forward at least a subset of the data messages that need the service to the newly deployed service machine or machines and to perform the required service at the newly deployed service machine or machines. When additional service machines are deployed in a public cloud, the controller must configure network elements to forward data messages to both previously deployed service machines and the newly deployed service machines. The data messages that need the service are to be forwarded to both the previously deployed service machines in the primary cloud and the newly deployed service machines in the selected public cloud in order to utilize the new service machines. In doing so, previously deployed service machines will not reach a maximum capacity because the newly deployed service machine or machines provide the service for at least some of the data messages that need the service. Then, the process 600 ends.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

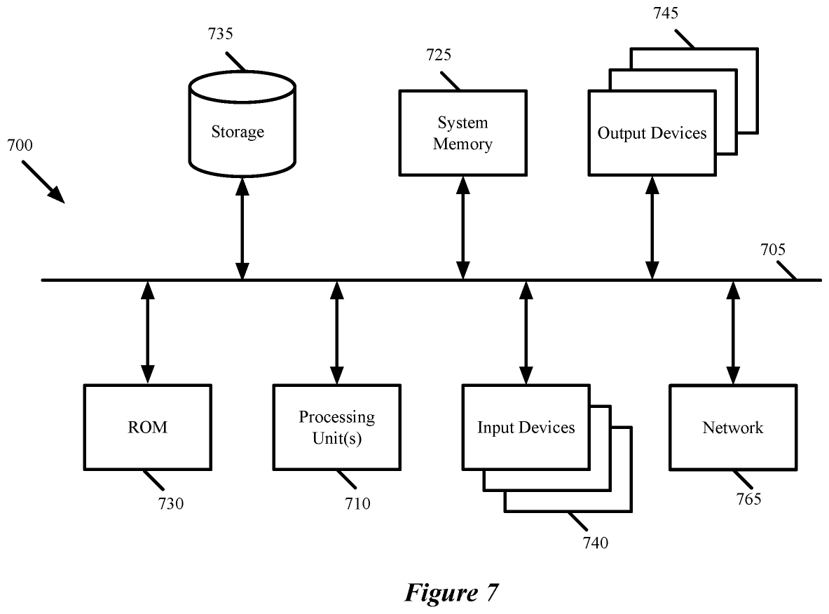

FIG. 7 conceptually illustrates a computer system 700 with which some embodiments of the invention are implemented. The computer system 700 can be used to implement any of the above-described computers and servers. As such, it can be used to execute any of the above described processes. This computer system includes various types of non-transitory machine readable media and interfaces for various other types of machine readable media. Computer system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) may be a single processor or a multi-core processor in different embodiments. The read-only-memory (ROM) 730 stores static data and instructions that are needed by the processing unit(s) 710 and other modules of the computer system. The permanent storage device 735, on the other hand, is a read-and-write memory device. This device is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a flash drive, etc.) as the permanent storage device. Like the permanent storage device 735, the system memory 725 is a read-and-write memory device. However, unlike storage device 735, the system memory is a volatile read-and-write memory, such a random access memory. The system memory stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices enable the user to communicate information and select commands to the computer system. The input devices 740 include alphanumeric keyboards and pointing devices (also called “cursor control devices”). The output devices 745 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 7, bus 705 also couples computer system 700 to a network 765 through a network adapter (not shown). In this manner, the computer can be a part of a network of computers (such as a local area network (“LAN”), a wide area network (“WAN”), or an Intranet, or a network of networks, such as the Internet. Any or all components of computer system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of deploying a secondary cluster of one or more service machines to a public secondary cloud to provide a service to supplement a primary cluster of service machines that provide the service in a primary cloud, the method comprising:
receiving a set of one or more user-defined criteria to use to deploy the secondary cluster of service machines in the public secondary cloud;
after receiving the set of user-defined criteria, detecting that the secondary cluster is needed to supplement the primary cluster of service machines;
retrieving previously collected data about a plurality of different public clouds that are candidates for the deployment of the secondary cluster of service machines;
based on the set of user-defined criteria, analyzing the previously collected data to select for the deployment a particular candidate public cloud as the public secondary cloud; and
deploying the secondary cluster of service machines in the selected particular public cloud.

2. The method of claim 1, wherein the set of user-defined criteria comprises a cost parameter and at least one performance parameter.

3. The method of claim 2, wherein the cost parameter is a financial cost charged by the public secondary cloud and the at least one performance parameter is at least one of (i) a latency metric, (ii) a capacity metric, (iii) a central processing unit (CPU) utilization metric, (iv) a memory utilization metric, (v) an error rate metric, and (vi) a mean-time-to-repair metric of the public secondary cloud.

4. The method of claim 2, wherein the cost and performance parameters are expressed as relative weight values to express relative importance of each parameter.

5. The method of claim 1, wherein the previously collected data comprises cost data and performance metric data retrieved from each candidate public cloud.

6. The method of claim 5 further comprising periodically retrieving the cost and performance metric data from each candidate public cloud.

7. The method of claim 1, wherein the different candidate public clouds comprise different public clouds of different public cloud providers.

8. The method of claim 1, wherein the different candidate public clouds comprise different public clouds of a first public cloud provider.

9. The method of claim 8, wherein the different public clouds of the first public cloud provider are in different availability zones of the first public cloud provider.

10. The method of claim 1, wherein the primary cloud is a private cloud.

11. The method of claim 1 further comprising selecting a particular datacenter of the selected particular public cloud and deploying the secondary cluster of service machines in the selected particular datacenter.

12. The method of claim 1, wherein the service is a middlebox service.

13. The method of claim 12, wherein the middlebox service is one of (i) a load balancing service, (ii) a firewall service, (iii) a deep packet inspection service, (iv) an intrusion detection system service, (v) an intrusion prevention service, (vi) a wide-area network link optimization service, or (vii) a network address translation service.

14. A non-transitory machine readable medium storing a program for execution by at least one processing unit for deploying a secondary cluster of one or more service machines to a public secondary cloud to provide a service to supplement a primary cluster of service machines that provide the service in a primary cloud, the program comprising sets of instructions for:
receiving a set of one or more user-defined criteria to use to deploy the secondary cluster of service machines in the public secondary cloud;
after receiving the set of user-defined criteria, detecting that the secondary cluster is needed to supplement the primary cluster of service machines;
retrieving previously collected data about a plurality of different public clouds that are candidates for the deployment of the secondary cluster of service machines;
based on the set of user-defined criteria, analyzing the previously collected data to select for the deployment a particular candidate public cloud as the public secondary cloud; and
deploying the secondary cluster of service machines in the selected particular public cloud.

15. The non-transitory machine readable medium of claim 14, wherein the set of user-defined criteria comprises a cost parameter and at least one performance parameter.

16. The non-transitory machine readable medium of claim 15, wherein the cost parameter is a financial cost charged by the public secondary cloud and the at least one performance parameter is at least one of (i) a latency metric, (ii) a capacity metric, (iii) a central processing unit (CPU) utilization metric, (iv) a memory utilization metric, (v) an error rate metric, and (vi) a mean-time-to-repair metric of the public secondary cloud.

17. The non-transitory machine readable medium of claim 15, wherein the cost and performance parameters are expressed as relative weight values to express relative importance of each parameter.

18. The non-transitory machine readable medium of claim 14, wherein the previously collected data comprises cost data and performance metric data retrieved from each candidate public cloud.

19. The non-transitory machine readable medium of claim 18, wherein the program further comprises sets of instructions for periodically retrieving the cost and performance metric data from each candidate public cloud.

20. The non-transitory machine readable medium of claim 14, wherein the service is a middlebox service.
